(19) United States
(12) Patent Application Publication
(10) Pub. No.: US 2005/0257259 A1
(43) Pub. Date: Nov. 17, 2005

(54) Method for controlling the re-use of prefilled reagent dispensers and other consumables

(76) Inventor: Jose De La Torre-Bueno, Carlsbad, CA (US)

Correspondence Address: FISH & RICHARDSON, PC, 12390 EL CAMINO REAL, SAN DIEGO, CA, 92130-2081, US

(21) Appl. No.: 10/844,678

(22) Filed: May 12, 2004

(51) Int. Cl. H04L 9/00

(52) U.S. Cl. 726/17

(57) ABSTRACT

This disclosure provides methods and systems by which a device could detect if it has been loaded with a consumable that was not authorized by the manufacturer of the device even if the gray market could exactly remanufacture or duplicate the consumable. The methods and systems utilize an asymetric key pair.

### TECHNICAL FIELD

This disclosure relates to reusable dispensers and consumable components and replacement systems.

### BACKGROUND

Many devices in medicine and other fields use consumable components that the manufacturer does not want to see refilled or reused. Examples are reagent dispensers that come prefilled with certified reagents for automatic slide stainers, probes for advanced surgical instruments and even ink-jet cartridges. In all of these fields there is an economic incentive for a gray market to come into existence to sell refilled, remanufactured or even counterfeit consumables.

Existing solutions to the problem of authenticating consumables have typically relied on patents on the physical apparatus or packaging. However this does not stop home refill operations or clone manufacture in countries with weak industrial property protection. Consequently a much higher level of protection is required. It is not enough to provide an authentication method that is secret, relying on a home-brew security method that has not been scrutinized by security experts. Security systems such as Netscape's original proprietary system and the GSM Fraud Prevention Network used by cellular phones are examples where design secrecy caused the vulnerability of the security. Both security systems were broken by conventional means that would have been detected if the companies had followed an open design process. The solution is to provide authentication by means that have withstood the scrutiny of experts.

### SUMMARY

The disclosure provides a component system, comprising one or more replaceable components; a code label on the one or more replaceable components; a component sensor in communication with the one or more replaceable components; a computer in communication with the component sensor; a computer readable program on the computer comprising a first key and instructions to cause the computer to detect the code label on a component; decode a code on the code label using the first key; determine if the code properly matches a present code; and indicating that the code matches.

The disclosure further provides an autostainer, comprising a component sensor in communication with one or more replaceable fluid containers; a computer in communication with the component sensor comprising a computer readable program comprising a first key; and instructions to cause the computer to detect a code label on the one or more replaceable fluid containers; decode a code on the code label using the first key; determine if the code properly matches a present code; and indicating that the code matches.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 shows an exemplary autostainer apparatus for use with the methods and systems of the disclosure.

FIG. 2 is a flow diagram showing an exemplary process of the disclosure.

Like reference symbols in the various drawings indicate like elements.

### DETAILED DESCRIPTION

Manufacturers of systems that require consumables (such as a automated microscope stainers, high performance equipment, laser printers and the like) have struggled with the problem of authenticating consumables. Most manufacturers have resorted to specialized packaging. However this does not stop home refill operations or counterfeit manufactures. The prevention of copying is important to prevent poorly manufactured substitute consumables from damaging the base system. For example, counterfeit staining cartridges may clog dispenser nozzles causing the consumer to blame the system manufacturer and resulting in increased repair/service calls, the cost of which may be incurred by the manufacturer, due to the use of non-authorized consumables by the user.

This disclosure provides a method by which a device could detect if it has been loaded with a consumable that was not authorized by the manufacturer of the device even if the gray market could exactly remanufacture or duplicate the consumable. The security scheme of the disclosure uses a secret key, not a secret algorithm. It will be recognized that a number of protocols can be used for consumable authentication, in addition to the specific key described herein.

In an exemplary embodiment, a consumable (e.g., a replaceable component) comprises a code label (e.g., a custom machine-readable label) and a device, which uses the consumable. The device comprises a component sensor, a memory and a calculating component (e.g., a computer) to execute cryptographic algorithms.

The disclosure is the use of key pairs (also called asymmetric) encryption algorithms. In standard block ciphers knowing how to encode a message implies knowing how to decode it and visa versa. In an asymmetric cipher there are 2 keys, any text modified by one key can be converted back by the other but knowing one key does not make it possible to infer the other.

An asymmetric encryption system is used as a method of authentication. If a manufacturer composes a message and processes it with one key (key₂), they will create a string of gibberish, which has the unique property that if transformed with the corresponding key (key₁) it becomes readable. Only the owner (i.e., the manufacturer) of the secret key (key₂) could make a message with this property, therefore a device comprising the corresponding key (key₁) can confirm that a message really came from the owner (i.e., manufacturer) of key₂. Because of the computational cost of asymmetric ciphers actual schemes are more complex using the asymmetric cipher for a critical part of a message and a faster conventional cipher for the body. As explained later because the amount of text that needs security is minimal in this scheme these timesavings are not necessary, however, they may be implemented if desired. The disclosure will be described in terms of an autostainer that uses prefilled reagent dispensers but it will be recognized that the methods and systems of the disclosure could be used with any kind of consumable, which is attached to some base device. The first embodiment describes a system to be used when the consumables are ordered from the manufacturer for use on a given device. Another embodiment describes a system in which consumables are delivered off-the-shelf when the manufacturer does not know in advance which individual item will go to a given customer or be used in a given device.

A reagent dispenser for use with an autostainer comprises a code label identifying critical information including, for example, the manufacturer, lot number, fill date, expiration date, and the like. This information is printed and may be encoded in a machine-readable form such as a bar code, RFID tag, embedded memory or the like. In this embodiment, the machine-readable label comprises a unique encrypted identifier and the serial number of the stainer the customer is supposed to use the consumable on, in addition to any other information. The encrypted identifier comprises manufacturer specific information. The manufacturer specific information may include a serial number, information related to which (if any) this reagent dispenser is in a series of reagent dispensers used in the device, and the like. The manufacturer specific information is encrypted using an asymmetric key system as described herein. For example, the manufacturer specific information may be encrypted using key₂, as described above.

The manufacturer retains in secret any encryption key (key₂) to an asymmetric cipher and the stainer device comprises the decryption key (key₁) in its memory. Whenever a consumable (e.g., a reagent dispenser) is made, the manufacturer encrypts the manufacturer specific information on to a machine-readable label using key₂ of an asymmetric key pair. Whenever a consumable (e.g., a reagent dispenser) is loaded onto or into the device (e.g., the stainer), the device will read the machine-readable label on the consumable (e.g. the reagent dispenser) and decode it with the corresponding decryption key (key₁) present on a computer readable media. A computer will then check the serial number of the given device (e.g., a given stainer) with the serial number obtained from the machine readable label present on the consumable (e.g., the replacement reagent dispenser) to determine if the serial numbers correspond such that the consumable (e.g., the reagent dispenser) is intended for the given device (e.g., a given autostainer). The device will also record a unique identifier (e.g., a serial number) associated with the consumable in a non-volatile memory. If the consumable is labeled with the serial number of a different device or the unique identifier (e.g., serial number) associated with the consumable indicates the consumable has been loaded previously on the device, the device will not run. The label information itself would almost surely by duplicated on the consumable in human readable text; however, because of the encryption and the additional parameters surrounding the recognition of the consumable (e.g., matching of serial numbers and storage of serial numbers) a counterfeit consumable would not be readily usable on a device.

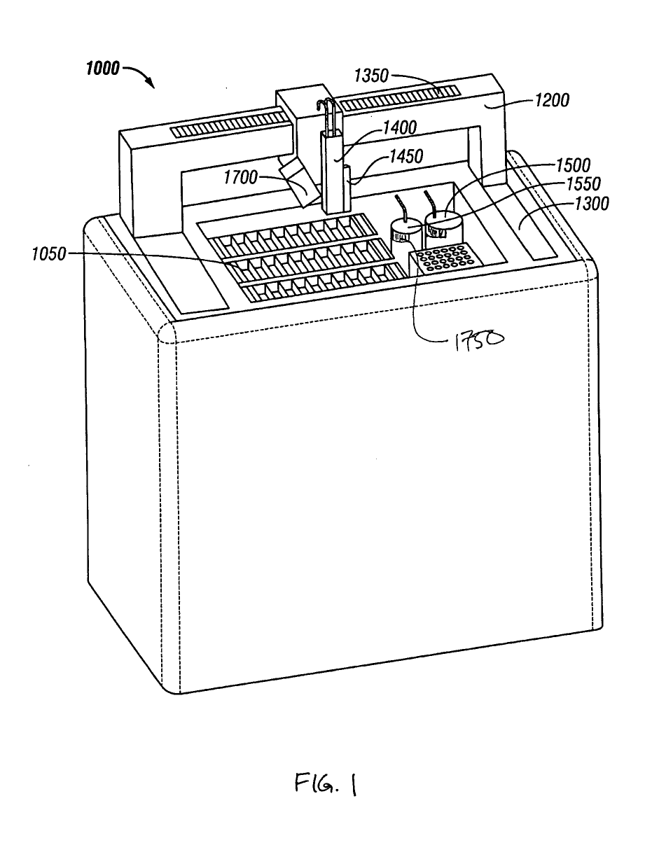

Referring to FIG. 1, the autostainer 1000 provided herein comprises a stage 1050 for supporting at least one slide (in certain aspects the stage supports a cassette capable of holding a plurality of slides). In yet another aspect, the stage 1050 is movable. The autostainer further comprises a positioning arm 1200. The positioning arm 1200 is movably located on an X-track 1300, which allows movement of the arm in an X-axis across the stage 1050. The positioning arm 1200 comprises a Y-track that allows for the positioning of a dispenser 1400 in a Y-axis. During operation the dispenser 1400 is capable of movement, relative to the stage, in both an X- and/or Y-axis, thereby allowing for the dispenser 1400 to be positionally located over a particular slide or position of the stage 1050. For example, the positioning arm may be movable in an X-Y and Z direction in the absence of “tracks” and can utilize various hinged and piviting members. Alternatively, a slide to be stained may be located on a movable stage or the reagent dispensers may be located on a movable stage, wherein the stage comprises X- and Y-motors to allow positioning of a dispenser relative to the slide. In another alternative, the dispenser may be associated with the X-track rather than the Y-track as described above. Such variations are within the scope of the device and the disclosure. The autostainer also comprises at least one reagent reservoir 1500. The reagent reservoir contains reagents used in staining a biological sample. The reagent reservoir are replaceable consumables (e.g., components that can be removed and replaced when empty). The reagents contained in the reagent reservoirs 1500 are pumped through tubing 1550 and to dispenser 1400 using a pump.

The positioning arm 1200 further comprises a camera 1700. The camera 1700 can be any number of commercially available camera-types and include various optical sensing array systems such as a CCD camera. The camera can serves as a sensor to identify labels on replaceable reagent reservoirs. The camera 1700 is positioned (or can be movably positioned) such that it can acquire an image of a label 1750 on a replaceable reagent reservoir of autostainer 1000. Various lenses may be optionally included in order to obtain magnified images. The camera 1700 is in electrical communication with a computer system, which is capable of analyzing images acquired by the camera to decipher a label code on the label 1750 (e.g., a bar code).

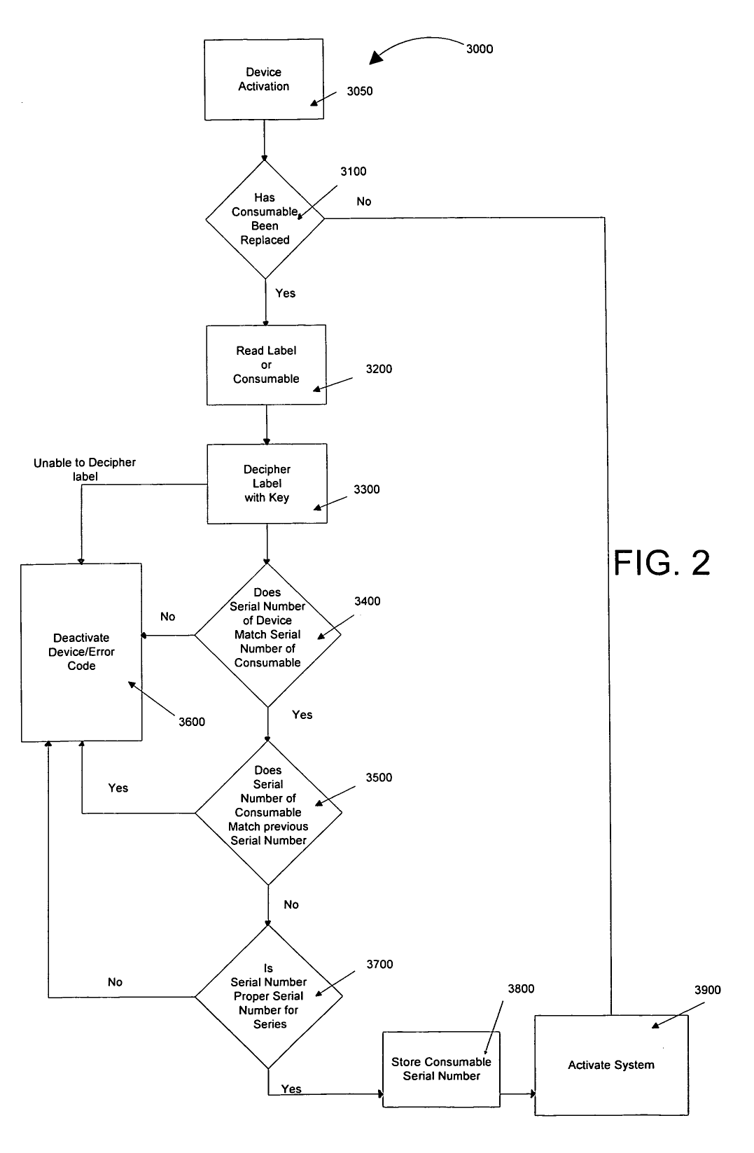

FIG. 2 shows a flow chart depicting an example of the processing methods of the disclosure. In process 3000, a device is activated 3050. Upon activation, a device first determines if a consumable has been replaced 3100. A simple toggle switch in the device associated with the placement and removal of a consumable can detect if a consumable has been replaced. Alternatively, a fluid level can be measured in such consumables as an ink jet cartridge or a reagent reservoir. If the fluid reservoir is different (e.g., higher or lower) than previously measure then this would be indicative that the consumable has been replaced.

The device reads a machine-readable label at 3200 using, for example, camera 1700 (see FIG. 1). The machine-readable label is deciphered 3300 using a decryption key present on an associated computer. The decrypted code comprising a serial number for the device that the consumable is designed for and/or a serial number of the actual consumable is then compared to stored serial number values in computer memory 3400. If the serial number of the device does not match that serial number for which the consumable was designated the system will indicate and error and the device will be deactivated 3600. If the serial number of the device matches the serial number of designated device of the consumable, the computer then compares the serial number of the specific consumable 3500. If the serial number of the specific consumable matches a serial number in memory related to previous consumables then the device is deactivated and an error message is indicated 3600. If the serial number does not match a prior serial number the device then determines if the serial number is the proper serial number 3700. If the serial number is not a proper serial number the device indicates and error and deactivates 3600. If the serial number is proper, the serial number is stored in memory 3800 and the device is set to a use mode 3900.

To see how this provides the desired security consider that a gray market manufacturer might attempt to create a consumable. If the gray market manufacturer simply refills an empty consumable the gray market manufacturer will not be able to use the consumable on the device (e.g., a stainer) it was labeled for since the device remembers seeing the consumable (based upon the consumable's serial number). A user will not be able to use the consumable on another device (e.g., strainer) because the target device serial number will not match the serial number encoded on the consumable's label. Reusing or refilling a consumable will have the same problem; the consumable will only work on a target system the first time it is used. The second time a consumable with the same serial number is mounted the device will not run.

In order to spoof the system the gray market manufacturer would need to be able to make a consumable with a new serial number and label the consumable with the number of the target device (e.g., stainer). This information would need to appear in the encrypted machine-readable portion of the consumable label. A gray market manufacturer could learn the public key by disassembling the software in the processor of the device (e.g., stainer) and this would allow them to read the encoded labels but this information would normally be on the text label anyway. Because the encoded label is an asymmetric cipher, even if the gray market manufacture knew what the label said and designed a new label with a different serial number and knew the target device's serial number the gray mark manufacturer could not encrypt the new label because the gray market manufacturer would not have the encryption key (key₂).

Asymmetric ciphers are computationally expensive and most digital signature systems use a hash value derived from the message as an authentication of a message but in this case a only few hundred bytes need be decoded and only the one time when the consumable is mounted. Because of this the manufacturer could choose an asymmetric cipher with a key long enough to provide very high certainty that it had not been broken and could encrypt the entire label with that key.

If the consumable has an expiration date, which most do, then the unit will not use a consumable with a passed expiration date. Therefore the unit can safely purge the memory of any consumable it ran in the past whose expiration date has now passed since it would not run a refill or duplicate of that consumable anyway because of the date.

A customer with several stainers will want to order supplies for all of them at once and will not want to track which consumable is targeted at which stainer. This scheme can be adapted to work on a set of stainers if they are connected by a network. This is not an onerous requirement since there are other reasons it is desirable to connect the stainers to the laboratory information system. In this variation all stainers at a customer site have the same target number but whenever one loads a consumable the device informs the other devices that also remember the serial number of that consumable. Therefore an attempt to load a refilled consumable will fail even if it is put on a different stainer. If the network is temporarily down the stainers can communicate which consumables are mounted when the network connection is renewed. This would not prevent a refilled consumable (refilled after the network went down) from being run on a different stainer while the network was down, but the fact would be discovered as soon as the connection was reestablished.

For some types of consumables it may not be practical to have a target unit serial number on each consumable. For instance the consumables might be sold by distributors who do not want inventory targeted to particular customers. Another version or this scheme would use only the serial number of the disposal and not a serial number for the target unit. Although this scheme could be spoofed there are limitations which would still inhibit a gray market manufacturer. Since any unit remembers all consumables mounted on it, a gray market refiller would have to take care never to send a refilled consumable back to the same customer since it would fail if it were mounted on the same unit. This would be very difficult if as posited the distribution system were not designed to direct specific shipments to specific customers. The result would be that gray market consumables would work sometimes but occasionally fail which would tie into the legitimate manufacturer's market message that only their original products should be used.

The problem is even greater for a forger who plans to counterfeit the consumable. They could buy one and duplicate the encrypted machine-readable label but all of the inventory would have the same serial number and the experience of a customer would be that they would never work more than once. To make useable forgeries the forger would need to put different serial numbers on them and lacking the private key they cannot make a label that differs in even a single character and encrypt it.

The commercially available RSA algorithm is an example of a type of asymmetric algorithm useful in the methods and systems of the disclosure. The RSA cryptosystem, named after Rivest, Shamir, and Adleman, is the most widely used public-key cryptosystem, and is a de facto standard in much of the world. The RSA algorithm patent was issued in 1983 (U.S. Pat. No. 4,405,829). The RSA cryptosystem is based on modular exponenetiation modulo the product of two large primes. One individual or device has an encryption key consisting of a modulus n=pq, where p and q are large primes, say with 200 digits each, and an exponent e that is relatively prime to (p−1)(q−1). To produce a usable key, two large primes must be found. This can be done quickly on a computer using probablistic primerality tests. However, the product of these primes n=pq, with approximately 400 or more digits, cannot be factored in a reasonable length of time. This is the reason why decryption cannot be done quickly without a separate decryption key.

An asymmetric encryption algorithm is one where the encryption function E relies on a first key (e.g., key₂) and the decryption function D relies on a second key (e.g., key₁). Furthermore, key₂ cannot be derived from key₁ in a reasonable amount of time, and key₁ cannot be derived from key₂ in a reasonable amount of time. Thus, E_{key2}[M]=C and D_{key1}[C]=M.

These algorithms are sometimes referred to as public-key systems (or key pairs) because one key (key₂) is used to encrypt a message, but only the corresponding decryption key (key₁) can decrypt and thus read the message. In most cases, the following identity also holds: E_{key2}[M]=C and D_{key1}[C]=M.

This identity implies that anyone with the decryption key (key₁) can see M and know that it came from the owner of key₂. Notable is the fact that no one else could have generated C because to do so would imply knowledge of key₂. What has been demonstrated is that a calculation that was thought to require a long time has been made possible by the introduction of faster computers, new algorithms etc. The security of asymmetric algorithms is based on the difficulty of factoring large numbers (e.g., large numbers that are the product of two large primes) and the difficulty of calculating discrete logarithms in a finite field. Factoring large numbers is conjectured to be a hard problem given today's understanding of mathematics. If the key is to last for some years then 1024 bits may not even be enough. It has been estimated that 1628 bits are needed for high security lasting until 2005, and that 1884 bits for security lasting until 2015. It has also been suggested 2048 bits are required in order to protect against corporations and governments until 2015.

A number of asymmetric (key pair) cryptographic algorithms exist, such as the RSA system described above. Most are impractical to implement, and many generate a very large C for a given M or require enormous keys. Still others, while secure, are far too slow to be practical for several years. Because of this, many public-key systems are hybrid—a public key mechanism is used to transmit a symmetric session key, and then the session key is used for the actual messages.

Of the practical algorithms in use under public scrutiny, the following can be used in the methods and systems of the disclosure: RSA, DSA, and ElGamal.

The RSA system has been described above. DSA (Digital Signature Standard) is an algorithm designed as part of the Digital Signature Standard (DSS). As defined, it cannot be used for generalized encryption. In addition, compared to RSA, DSA is 10 to 40 times slower for signature verification. DSA explicitly uses the SHA-1 bashing algorithm. DSA key generation relies on finding two primes p and q such that q divides p−1. According to Schneier, a 1024-bit p value is required for long term DSA security. However the DSA standard does not permit values of p larger than 1024 bits (p must also be a multiple of 64 bits). The US Government owns the DSA algorithm and has at least one relevant patent (U.S. Pat. No. 5,231,688 granted in 1993).

The ElGamal scheme is used for both encryption and digital signatures. The security is based on the difficulty of calculating discrete logarithms in a finite field. Key selection involves the selection of a prime p, and two random numbers g and x such that both g and x are less than p. Then calculate y=gx mod p. The public key is y, g, and p. The private key is x.

A number of embodiments of the disclosure have been described. Nevertheless, it will be understood that various modifications may be made without departing from the spirit and scope of the disclosure. Accordingly, other embodiments are within the scope of the following claims.

1. A component system, comprising
one or more replaceable components;
a code label on the one or more replaceable components;
a component sensor in communication with the one or more replaceable components;
a computer in communication with the component sensor;
a computer readable program on the computer comprising a first key and instructions to cause the computer to:
detect the code label on a component;
decode a code on the code label using the first key;
determine if the code properly matches a present code; and
indicating that the code matches.

2. The component system of claim 1, wherein the one or more replacement components comprises computer hardware or refillable fluid containers.

3. The component system of claim 1, wherein the code label comprises a bar code.

4. The component system of claim 3, wherein the component sensor is a bar code reader.

5. The component system of claim 1, wherein the first key is one key of an asymmetric encryption key system.

6. The component system of claim 1, wherein the code label comprises information selected from the group consisting of a serial number of the consumable, a serial number of a device that uses the consumable, an expiration date of the consumable, and any combination thereof.

7. The component system of claim 6, wherein the information is encrypted using a second key of an asymmetric encryption key system.

8. An autostainer, comprising
a component sensor in communication with one or more replaceable fluid containers;
a computer in communication with the component sensor;
a computer readable program on the computer comprising
a first key; and
instructions to cause the computer to:
detect a code label on the one or more replaceable fluid containers;
decode a code on the code label using the first key;
determine if the code properly matches a present code; and
indicating that the code matches.

9. The autostainer of claim 8, wherein the code label comprises a bar code.

10. The autostainer of claim 8, wherein the component sensor is a bar code reader.

11. The autostainer of claim 8, wherein the first key is one key of an asymmetric encryption key pair.

12. The autostainer of claim 8, wherein the code label comprises information selected from the group consisting of a serial number of the consumable, a serial number of a device that uses the consumable, an expiration date of the consumable, and any combination thereof.

13. The autostainer of claim 12, wherein the information is encrypted using a second key of an asymmetric encryption key system.
